(19) United States
(12) Patent Application Publication
(10) Pub. No.: US 2025/0164116 A1
(43) Pub. Date: May 22, 2025

(54) Pizza Oven

(71) Applicant: LEPAIER GLOBAL CO., LTD., ShenZhen (CN)

(72) Inventors: Guangrong Zhang, ShenZhen (CN); Guoming Yuan, ShenZhen (CN); Bo Cheng, ShenZhen (CN); Weidong Jin, ShenZhen (CN)

(21) Appl. No.: 19/027,062

(22) Filed: Jan. 17, 2025

(30) Foreign Application Priority Data
Jan. 29, 2024 (CN) 202420221099.7

(51) Int. Cl. F24C 1/06; F24B 13/04; F24C 3/08; F24C 7/06

(52) U.S. Cl. CPC F24C 1/06; F24B 13/04; F24C 3/087; F24C 7/06

(57) ABSTRACT

A pizza oven is provided, and relates to the technical field of ovens. The pizza oven includes an oven body and a heating assembly; a baking chamber and a plug-in slot connected to the baking chamber are formed in the oven body; the heating assembly includes a pellet hopper, a gas assembly, and an electrical assembly; the pellet hopper, the gas assembly, and the electrical assembly are respectively detachably plugged into the plug-in slot; the pellet hopper is plugged into the plug-in slot to achieve a first heating state; the gas assembly is plugged into the plug-in slot to achieve a second heating state; and the electrical assembly is plugged into the plug-in slot to achieve a third heating state.

### TECHNICAL FIELD

The present disclosure relates to the technical field of ovens, and in particular, to a pizza oven.

### BACKGROUND

At present, according to different types of fuel, pizza ovens on the market include an electric pizza oven, a gas pizza oven, and a pellet fuel pizza oven. The electric pizza oven heats a baking chamber through an electric heating tube. The gas pizza oven heats a baking chamber through a gas assembly. The pellet fuel pizza oven heats a baking chamber through combustible pellets (such as carbon pallets and firewood pellets). The pizza ovens in all the forms can only use a single type of fuel, and the fuel cannot be replaced according to different usage environments.

### SUMMARY

The present disclosure aims to provide a pizza oven compatible with different heating assemblies, so that one of pellet fuel, gas, and electricity can be selected to heat the pizza oven according to different usage scenarios.

To achieve the above objectives, a pizza oven according to the present disclosure includes an oven body and a heating assembly; a baking chamber and a plug-in slot connected to the baking chamber are formed in the oven body; the heating assembly includes a pellet hopper, a gas assembly, and an electrical assembly; the pellet hopper, the gas assembly, and the electrical assembly are respectively detachably plugged into the plug-in slot; the pellet hopper is plugged into the plug-in slot to achieve a first heating state; the gas assembly is plugged into the plug-in slot to achieve a second heating state; and the electrical assembly is plugged into the plug-in slot to achieve a third heating state.

Optionally, a partition plate is arranged in a chamber of the oven body to divide the chamber of the oven body into a first chamber and a second chamber; a volume of the first chamber is greater than a volume of the second chamber; the first chamber is the baking chamber; a first opening is provided in the partition plate to connect the first chamber to the second chamber; a bottom edge of the first opening is flush with a bottom plate of the oven body; and a second opening opposite to the first opening is provided in a back plate of the oven body. A first baffle plate, a second baffle plate, and a third baffle plate are arranged in the second chamber; the first baffle plate and the second baffle plate are oppositely arranged on two sides of the first opening to be connected to the first opening and the second opening; the third baffle plate is arranged on a top surface of the first baffle plate and a top surface of the second baffle plate to connect the first baffle plate to the second baffle plate; and the bottom plate of the oven body, the first baffle plate, the second baffle plate, and the third baffle plate are enclosed to form the plug-in slot.

Optionally, a flue is arranged in the baking chamber; one end of the flue is connected to the first opening; and the other end of the flue tilts upwards and is connected to an upper space of the baking chamber.

Optionally, the pizza oven further includes a pellet fuel assembly; the pellet fuel assembly includes a feeding assembly and an ash box; the feeding assembly is arranged above the plug-in slot and is connected to the plug-in slot; the ash box is arranged below the plug-in slot and is connected to the plug-in slot; and when the pellet hopper is plugged into the plug-in slot, the feeding assembly is configured to add pellet fuel into the pellet hopper; and the ash box is configured to receive ash obtained after combustion of pellet fuel.

Optionally, the feeding assembly includes a feeding tube and a cover plate; the feeding tube is formed with a feeding channel with openings in two ends; a material inlet is provided in a top wall of the plug-in slot; the feeding tube is plugged into the plug-in slot through the material inlet to connect the feeding channel with the plug-in slot; the cover plate is covered at the opening in an upper end of the feeding tube and is hinged to the feeding tube; and the cover plate has a state of uncovering the feeding channel and a state of blocking the feeding channel.

Optionally, a material outlet is provided in a bottom wall of the plug-in slot to connect the plug-in slot to a chamber of the ash box; the pellet hopper includes a hopper body and a carrier plate; the carrier plate is obliquely arranged in a compartment of the hopper body and divides the compartment of the hopper body into a first compartment at an upper layer and a second compartment at a lower layer; the carrier plate is provided with several ash holes to connect the first compartment to the second compartment; an ash port is provided in a bottom wall of the hopper body; the ash port is opposite to the material outlet; and ash on the carrier plate falls into the second compartment from the first compartment through the ash holes, and then falls into the ash box through the ash port and the material outlet.

Optionally, air inlet holes are provided in a back wall of the hopper body to connect the second compartment to an external environment.

Optionally, a handle is arranged on a back wall of the hopper body, and the handle is detachably connected to the hopper body.

Optionally, the gas assembly includes a gas shell; a first mounting piece is arranged on a peripheral side of the gas shell; and the first mounting piece is configured to be fixedly connected to a back plate of the oven body.

Optionally, the electrical assembly includes an electrical appliance shell; a second mounting piece is arranged on a peripheral side of the electrical appliance shell; and the second mounting piece is configured to be fixedly connected to a back plate of the oven body.

According to the present disclosure, the pizza oven includes the oven body, and the pellet hopper, the gas assembly, and the electrical assembly which are matched with the oven body for use. The baking chamber and the plug-in slot connected to the baking chamber are formed in the oven body. A pizza stone is placed at a bottom of the baking chamber. The pizza stone heats a pizza placed on the pizza stone by absorbing heat inside the baking chamber. The plug-in slot is configured to plug one of the pellet hopper, the gas assembly, and the electrical assembly, to achieve three modes for baking a pizza. Compared with the conventional pizza oven, the pizza oven has the advantages that fuel can be replaced according to a need, which is beneficial for expanding usage scenarios of the pizza oven and achieving multiple purposes in one oven.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings according to structures shown in these accompanying drawings without creative efforts.

FIG. 1 is a schematic structural diagram of a pizza oven according to an embodiment of the present disclosure;

FIG. 2 is a partially cross-sectional view of a pizza oven according to an embodiment of the present disclosure;

FIG. 3 is a cross-sectional structural diagram of a pellet hopper of a pizza oven according to an embodiment of the present disclosure;

FIG. 4 is a cross-sectional view of plugging a pellet hopper into a plug-in slot in a pizza oven according to an embodiment of the present disclosure;

FIG. 5 is an exploded view of a gas assembly of a pizza oven according to an embodiment of the present disclosure;

FIG. 6 is a cross-sectional view of plugging a gas assembly into a plug-in slot in a pizza oven according to an embodiment of the present disclosure;

FIG. 7 is a schematic structural diagram of an electrical assembly of a pizza oven according to an embodiment of the present disclosure; and

FIG. 8 is a cross-sectional view of plugging an electrical assembly into a plug-in slot in a pizza oven according to an embodiment of the present disclosure.

### DESCRIPTION OF REFERENCE NUMERALS

| | | | | | |
|---|---|---|---|---|---|
| 11 | Baking | 2111 | Ash port | 225 | Switch knob |
| | chamber | | | | |
| 111 | Pizza stone | 2112 | Air inlet hole | 226 | Ignition rod |
| 12 | Plug-in slot | 2113 | Handle | 23 | Electrical |
| | | | | | assembly |
| 13 | Partition | 212 | Carrier plate | 231 | Electrical |
| | plate | | | | appliance |
| | | | | | shell |
| 14 | First baffle | 2121 | Ash hole | 2311 | Second |
| | plate | | | | mounting |
| | | | | | piece |
| 15 | Second | 213 | First | 232 | Electric |
| | baffle plate | | compartment | | heating tube |
| 16 | Third baffle | 214 | Second | 31 | Feeding |
| | plate | | compartment | | assembly |
| 17 | Material | 22 | Gas assembly | 311 | Feeding tube |
| | inlet | | | | |
| 18 | Material | 221 | Gas shell | 312 | Cover plate |
| | outlet | | | | |
| 19 | Flue | 2211 | First | 32 | Ash box |
| | | | mounting | | |
| | | | piece | | |
| 2 | Heating | 222 | Air supply | 4 | Chimney |
| | assembly | | tube | | |

The implementations, functional features, and advantages of the present disclosure will be further explained in conjunction with the embodiments and with reference to the accompanying drawings.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

It should be noted that all directional indications (such as up, down, left, right, front, back, . . . ) involved in the embodiments of the present disclosure are only used to explain the relative positional relationship, motion states, and the like between various components in specific postures (as shown in the accompanying drawings). If the specific postures change, the directional indications also change correspondingly.

In addition, the descriptions of the terms “first”, “second”, and the like in the present disclosure are used for descriptive purposes only and are not to be construed as indicating or implying relative importance or to implicitly indicate the number of technical features indicated. From this, features defined as “first” and “second” may explicitly or implicitly include at least one feature. In addition, the technical solutions between the various embodiments can be combined with each other, but need to be implemented by those of ordinary skill in the art. When there is a conflict in a combination of technical solutions or the combination cannot be achieved, it should be considered that the combination of the technical solutions does not exist and does not fall within the protection scope of the present disclosure.

At present, according to different types of fuel, pizza ovens on the market include an electric pizza oven, a gas pizza oven, and a pellet fuel pizza oven. The electric pizza oven heats a baking chamber through an electric heating tube. The gas pizza oven heats a baking chamber through a gas assembly. The pellet fuel pizza oven heats a baking chamber through combustible pellets (such as carbon pellets and firewood pellets). The pizza ovens in all the forms can only use a single type of fuel, and the fuel cannot be replaced according to different usage environments.

In view of this, the present disclosure provides a pizza oven 100.

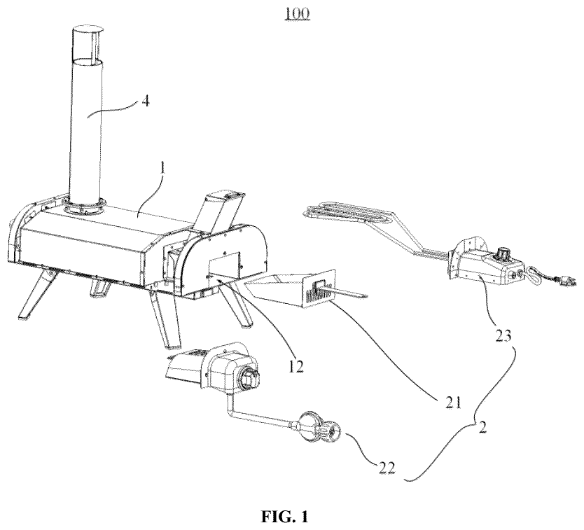

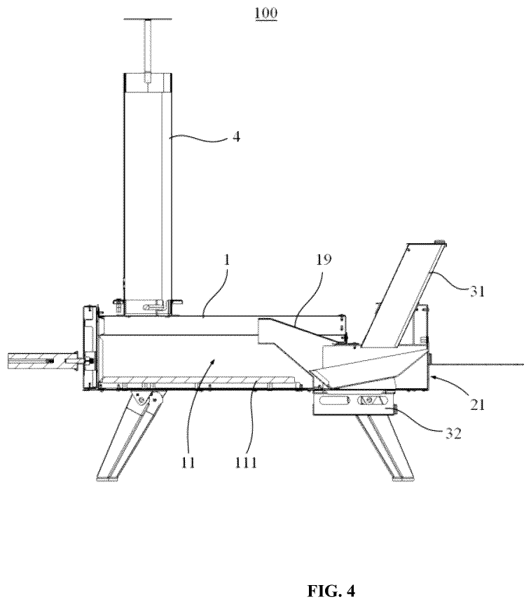

Referring to FIG. 1 to FIG. 8, the pizza oven 100 of the present disclosure includes an oven body 1 and a heating assembly 2. A baking chamber 11 and a plug-in slot 12 connected to the baking chamber 11 are formed in the oven body 1; a heating assembly 2 includes a pellet hopper 21, a gas assembly 22, and an electrical assembly 23; the pellet hopper 21, the gas assembly 22, and the electrical assembly 23 are respectively detachably plugged into the plug-in slot 12; the pellet hopper 21 is plugged into the plug-in slot 12 to achieve a first heating state; the gas assembly 22 is plugged into the plug-in slot 12 to achieve a second heating state; and the electrical assembly 23 is plugged into the plug-in slot 12 to achieve a third heating state.

According to this embodiment, the pizza oven 100 includes the oven body 1, and the pellet hopper 21, the gas assembly 22, and the electrical assembly 23 which are matched with the oven body 1 for use. The baking chamber 11 and the plug-in slot 12 connected to the baking chamber 11 are formed in the oven body 1. A pizza stone 111 is placed at a bottom of the baking chamber 11. The pizza stone 111 heats a pizza placed on the pizza stone 111 by absorbing heat inside the baking chamber 11. The plug-in slot 12 is configured to plug one of the pellet hopper 21, the gas assembly 22, and the electrical assembly 23.

The pellet hopper 21 is configured to hold a granular combustible material (such as carbon pellets and firewood pellets). After the granular combustible material is ignited with an ignition source, the pellet hopper 21 is plugged into the plug-in slot 12. Heat generated by the combustible material acts on the baking chamber 11, thereby achieving a first mode for baking a pizza. When the gas assembly 22 is plugged into the plug-in slot 12, after a gas cylinder is connected, a switch knob 225 is pushed and turned to an ignition position, thereby achieving a second mode for baking a pizza. When the electrical assembly 23 is plugged into the plug-in slot 12, after a power supply is connected, a switch on a circuit control assembly is turned on, and an electric heating tube 232 is switched on to generate heat, thereby achieving a third mode for baking a pizza.

It should be noted that the pellet hopper 21 is not fixedly connected to the oven body 1, making it easy to plug or remove the pellet hopper 21 at any time. The gas assembly 22 includes a gas shell 221; a first mounting piece 2211 is arranged on a peripheral side of the gas shell 221; and the first mounting piece 2211 is configured to be fixedly connected to a back plate of the oven body 1. When the gas assembly 22 is used for baking, the gas shell 221 is partially plugged into the plug-in slot 12 until the first mounting piece 2211 resists against the back plate of the oven body 1. The first mounting piece 2211 and the back plate of the oven body 1 are provided with corresponding threaded holes, and the first mounting piece 2211 is fixed to the oven body 1 by a screw. The electrical assembly 23 includes an electrical appliance shell 231; a second mounting piece 2311 is arranged on a peripheral side of the electrical appliance shell 231; and the second mounting piece 2311 is configured to be fixedly connected to a back plate of the oven body 1. When the electrical assembly 23 is used for baking, the electrical appliance shell 231 is at least partially plugged into the plug-in slot 12 until the second mounting piece 2311 resists against the back plate of the oven body 1. The second mounting piece 2311 and the back plate of the oven body 1 are provided with corresponding threaded holes, and the second mounting piece 2311 is fixed to the oven body 1 by a screw. When the gas assembly 22 or the electrical assembly 23 needs to be removed, only the screw needs to be removed.

In summary, compared with the conventional pizza oven 100, the pizza oven 100 has the advantages that fuel can be replaced according to a need, which is beneficial for expanding usage scenarios of the pizza oven 100 and achieving multiple purposes in one oven.

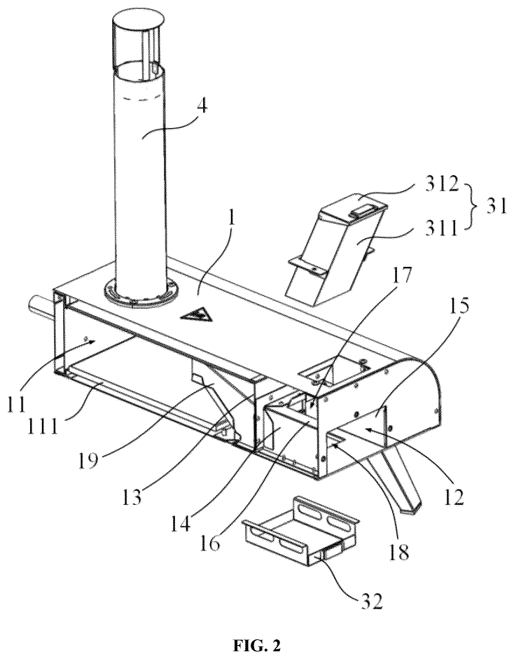

Referring to FIG. 2, in an embodiment of the present disclosure, a partition plate 13 is arranged in a chamber of the oven body 1 to divide the chamber of the oven body 1 into a first chamber and a second chamber; a volume of the first chamber is greater than a volume of the second chamber; the first chamber is the baking chamber 11; a first opening (not shown) is provided in the partition plate 13 to connect the first chamber to the second chamber; a bottom edge of the first opening is flush with a bottom plate of the oven body 1; and a second opening (not shown) opposite to the first opening is provided in a back plate of the oven body 1. A first baffle plate 14, a second baffle plate 15, and a third baffle plate 16 are arranged in the second chamber; the first baffle plate 14 and the second baffle plate 15 are oppositely arranged on two sides of the first opening to be connected to the first opening and the second opening; and the third baffle plate 16 is arranged on a top surface of the first baffle plate 14 and a top surface of the second baffle plate 15 to connect the first baffle plate 14 to the second baffle plate 15. The bottom plate of the oven body 1, the first baffle plate 14, the second baffle plate 15, and the third baffle plate 16 are enclosed to form the plug-in slot 12. During actual use, the pellet hopper 21/the gas assembly 22/the electrical assembly 23 is plugged into the plug-in slot 12 through the second opening. The pellet hopper 21 is movably connected to the oven body 1, and the first mounting piece 2211 or the second mounting piece 2311 is connected to the back plate of the oven body 1 through the screw.

Further, a chimney 4 is arranged at a top of the baking chamber 11, and a flue 19 is arranged inside the baking chamber 11. One end of the flue 19 is connected to the first opening, and the other end of the flue 19 tilts upwards and is connected to an upper space of the baking chamber 11. When the pellet hopper 21 or the gas assembly 22 is plugged into the plug-in slot 12, due to the effect of the chimney 4, flame will enter the baking chamber along the flue 19, and waste gas will be discharged along the chimney 4. It is not difficult to understand that if the flame directly acts on the pizza stone 111, food on the pizza stone 111 is easily burnt and has a scorched flavor, resulting in poor taste. Therefore, in this embodiment, the flue 19 is obliquely arranged, and the flame enters the upper space of the baking chamber through the flue 19, to heat the pizza stone 111 and the food on the pizza stone 111 from top to bottom to achieve a baking effect.

The embodiment of the pizza oven 100 further includes the a pellet fuel assembly; the pellet fuel assembly includes a feeding assembly 31 and an ash box 32; the feeding assembly 31 is arranged above the plug-in slot 12 and is connected to the plug-in slot 12; the ash box 32 is arranged below the plug-in slot 12 and is connected to the plug-in slot 12; and when the pellet hopper 21 is plugged into the plug-in slot 12, the feeding assembly 31 is configured to add pellet fuel into the pellet hopper 21; and the ash box 32 is configured to receive ash obtained after combustion of pellet fuel.

Specifically, referring to FIG. 2, the feeding assembly 31 includes a feeding tube 311 and a cover plate 312. The feeding tube 311 is formed with a feeding channel with openings in two ends; a material inlet 17 is provided in a top wall of the plug-in slot 12; an avoiding opening is provided in a top plate of the oven body 1; a size of the material inlet 17 and a size of the avoiding port are matched with a size of the feeding tube 311; the feeding tube 311 is plugged into the plug-in slot 21 through the avoiding port and the material inlet 17 from top to bottom, so that the feeding channel is connected to the plug-in slot 12. The cover plate 312 is covered at the opening in an upper end of the feeding tube 311 and is hinged to the feeding tube 311; and the cover plate 312 has a state of uncovering the feeding channel and a state of blocking the feeding channel.

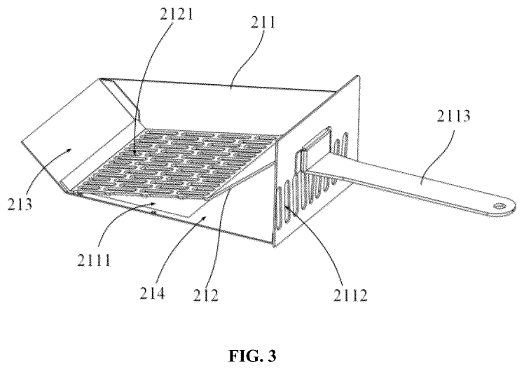

A material outlet 18 is provided in a bottom wall of the plug-in slot 12 to connect the plug-in slot 12 to a chamber of the ash box 32. Referring to FIG. 3, the pellet hopper 21 includes a hopper body 211 and a carrier plate 212; the carrier plate 212 is obliquely arranged in a compartment of the hopper body 211 and divides the compartment of the hopper body 211 into a first compartment 213 at an upper layer and a second compartment 214 at a lower layer; the carrier plate 212 is provided with several ash holes 2121 to connect the first compartment 213 to the second compartment 214; and the ash holes 2121 are arranged in a meshed array. An ash port 2111 is provided in a bottom wall of the hopper body 211; the ash port 2111 is opposite to the material outlet 18; and ash on the carrier plate 212 falls into the second compartment 214 from the first compartment 213 through the ash holes 2121, and then falls into the ash box 32 through the ash port 2111 and the material outlet 18.

The feeding tube 311 is obliquely arranged. When the pellet hopper 21 is plugged into the plug-in slot 12, the cover plate 312 is opened, and pellet fuel is poured into the feeding tube 311. The pellet fuel falls into the pellet hopper 21 and is stacked up to fill the feeding tube 311. Then, the cover plate 312 is closed. When the fuel at the bottom of the pellet hopper 21 is fully combusted into ash, the ash will fall into the ash box 32 after passing through the carrier plate 212. Meanwhile, a height of the fuel on the pellet hopper 21 decreases, and the fuel stacked in the feeding tube 311 falls off under the action of the gravity, thus continuously replenishing the fuel until the added fuel is combusted completely.

The ash box 32 is detachably connected to the bottom plate of the oven body 1 by, such as, screw connection and sliding chute connection. When the combustion quality of the pellet fuel is good (without producing too much ash), the ash box 32 can be removed, or when the ash box 32 is full of ash, the ash box 32 can be removed to discharge the ash.

Further, air inlet holes 2112 are provided in a back wall of the hopper body 211 to connect the second compartment 214 to an external environment. Environmental air can be blown from the air inlet 2112 towards the second compartment 214, and then flow into the first compartment 213 through the ash holes 2121, thereby improving the flowability of the air, supplementing oxygen, and improving the combustion efficiency of the pellet fuel.

A damper (not shown) can be arranged on the hopper body 211. The damper covers the air inlet hole 2112 and can slide up and down or left and right relative to the air inlet hole 2112, thereby adjusting a number or size of air inlet holes 2112 that are opened and adjusting an air intake volume.

A handle 2113 is arranged on aback wall of the hopper body 211, and the handle 2113 is detachably connected to the hopper body 211. A clamping seat is arranged on the back wall of the hopper body 211. An end portion of the handle 2113 is bent and provided with a clamping hook matched with the clamping seat. The clamping hook is plugged into the clamping seat and connected to the clamping seat. Thus, the handle 2113 can be used to push the hopper body 211 into or pull the hopper body 211 out of the plug-in slot 12. After being used, the handle 2113 can be removed from the clamping seat to prevent the operator from accidentally touching handle 2113 during operation and knocking over the pizza oven 100.

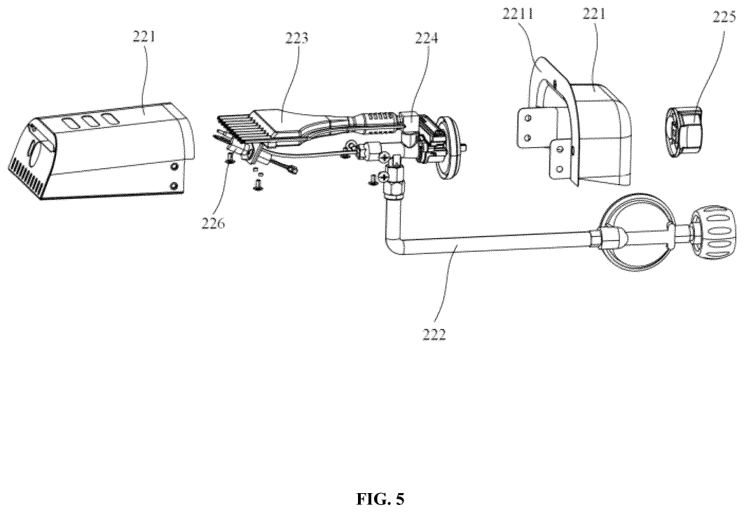

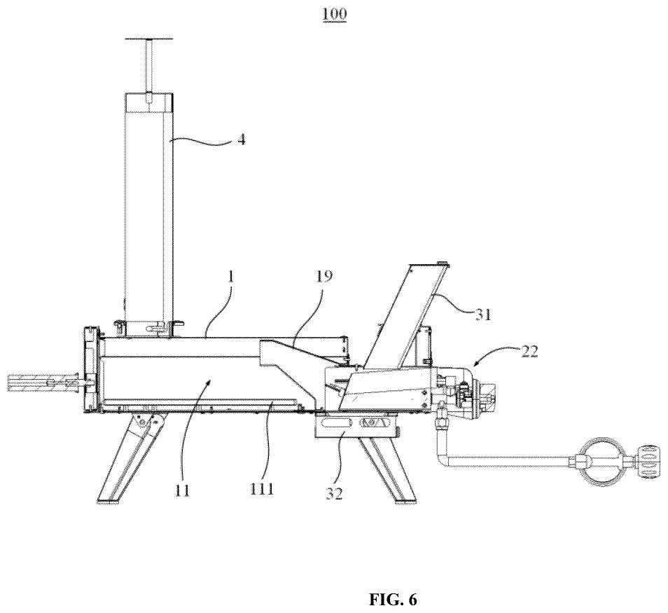

Referring to FIG. 5 and FIG. 6, the gas assembly 22 includes a gas shell 221, an air supply assembly, and an ignition assembly. A first mounting piece 2211 is arranged at a peripheral side of the gas shell 221 in a protruding manner. The first mounting piece 2211 is configured to be fixedly connected to the back plate of the oven body 1. The air supply assembly is arranged inside the gas shell 221. An input end of the air supply assembly is configured to be connected to a gas cylinder. An output end of the air supply assembly extends into the baking chamber 11 through the gas shell 221. The ignition assembly includes a switch knob 225 and an ignition rod 226. The switch knob 225 is mounted on an outer side of the gas shell 221, and the ignition rod 226 is arranged inside the gas shell 221 and extends to the output end of the air supply assembly. The ignition rod 226 is electrically connected to the switch knob 225, and is configured to ignite gas sprayed out from the output end of the air supply assembly. After the air supply tube 222 is connected to the gas cylinder, the switch knob 225 is pushed and turned to an ignition position. Gas is sprayed out from the output end of the air supply assembly and is ignited by the ignition rod 226, to complete ignition, thereby achieving the second mode for baking a pizza.

Specifically, the first mounting piece 2211 divides the gas shell 221 into a first shell and a second shell. The first shell is plugged into the plug-in slot 12, and the second shell is exposed to the oven body 1. The air supply assembly includes an air supply tube 222, a stamping furnace end 223, and a safety valve 224. The safety valve 224 is arranged in a chamber of the second shell. The stamping furnace end 223 is arranged in a chamber of the first shell. An input end of the air supply tube 222 is configured to be connected to the gas cylinder, and an output end of the air supply tube 222 is connected to the safety valve 224. The output end of the safety valve 224 is connected to an input end of the stamping furnace end 223, and an output end of the stamping furnace end 223 extends into the baking chamber 11 through the first shell. The safety valve 224 is installed between the air supply tube 222 and the stamping furnace end 223 to control the opening and closing of the air supply tube 222. In addition, the gas assembly 22 further includes a thermoelectric flameout protection system. The thermoelectric flameout protection system has a thermocouple. The thermocouple cooperates with an electromagnetic valve inside the safety valve 224. When flame of the gas assembly 22 is extinguished due to an external reason, a temperature at an end of the thermocouple decreases, and sufficient electromotive force cannot be generated, so that the electromagnetic valve is controlled to be closed to prevent further gas leakage.

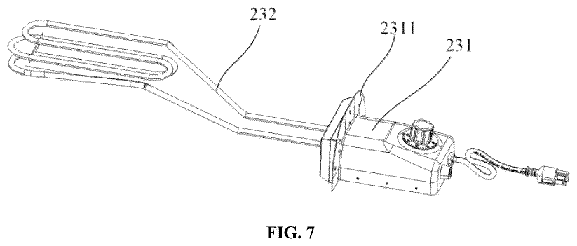

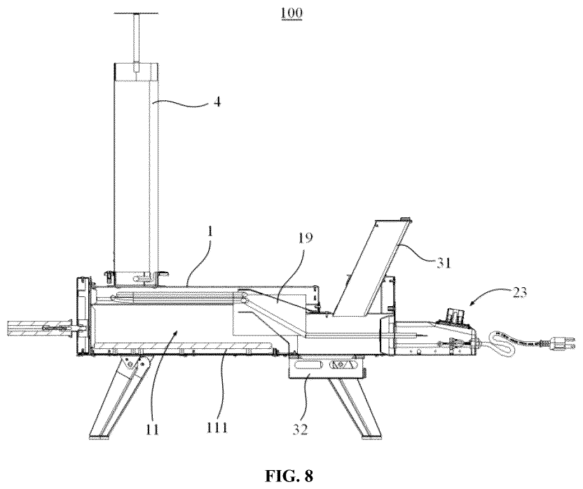

Referring to FIG. 7 and FIG. 8, the electrical assembly 23 includes an electrical appliance shell 231 and an electric heating assembly. A second mounting piece 2311 is arranged on a peripheral side of the electrical appliance shell 231 in a protruding manner, and the second mounting piece 2311 is configured to be fixedly connected to the back plate of the oven body 1. The electric heating assembly includes a circuit control assembly and an electric heating tube 232. The circuit control assembly is arranged inside the electrical appliance shell 231, and the electric heating tube 232 is electrically connected to the circuit control assembly and extends into the baking chamber 11. The circuit control assembly is connected with a power cable and a plug. After a power supply is connected, a switch on the circuit control assembly is turned on, and the electric heating tube 232 is switched on to generate heat, thereby achieving the third mode for baking a pizza.

The circuit control assembly has an overheating protection function. The circuit control assembly includes a temperature controller and a protector. The temperature controller is configured to monitor a temperature of the electric heating tube 232. When the temperature controller detects that the electric heating tube 232 is overheated, the protector controls a circuit to be switched off in a timely manner to maintain the electric heating tube within a normal working temperature range.

The above describes only preferable embodiments of the present disclosure and does not limit the patent scope of the present disclosure. Any equivalent structural transformations made using the specification and accompanying drawings of the present disclosure within the inventive concept of the present disclosure, or directly or indirectly applied in other related technical fields, all fall within the scope of patent protection of the present disclosure.

What is claimed is:

1. A pizza oven (100), comprising:
an oven body (1), wherein a baking chamber (11) and a plug-in slot (12) connected to the baking chamber (11) are formed in the oven body (1);
a heating assembly (2), wherein the heating assembly (2) comprises a pellet hopper (21), a gas assembly (22), and an electrical assembly (23); the pellet hopper (21), the gas assembly (22), and the electrical assembly (23) are respectively detachably plugged into the plug-in slot (12); the pellet hopper (21) is plugged into the plug-in slot (12) to achieve a first heating state; the gas assembly (22) is plugged into the plug-in slot (12) to achieve a second heating state; and the electrical assembly (23) is plugged into the plug-in slot (12) to achieve a third heating state.

2. The pizza oven (100) according to claim 1, wherein a partition plate (13) is arranged in a chamber of the oven body (1) to divide the chamber of the oven body (1) into a first chamber and a second chamber; a volume of the first chamber is greater than a volume of the second chamber; the first chamber is the baking chamber (11); a first opening is provided in the partition plate (13) to connect the first chamber to the second chamber; a bottom edge of the first opening is flush with a bottom plate of the oven body (1); a second opening opposite to the first opening is provided in a back plate of the oven body (1);
a first baffle plate (14), a second baffle plate (15), and a third baffle plate (16) are arranged in the second chamber; the first baffle plate (14) and the second baffle plate (15) are oppositely arranged on two sides of the first opening to be connected to the first opening and the second opening; the third baffle plate (16) is arranged on a top surface of the first baffle plate (14) and a top surface of the second baffle plate (15) to connect the first baffle plate (14) to the second baffle plate (15); and the bottom plate of the oven body (1), the first baffle plate (14), the second baffle plate (15), and the third baffle plate (16) are enclosed to form the plug-in slot (12).

3. The pizza oven (100) according to claim 2, wherein a flue (19) is arranged in the baking chamber (11); one end of the flue (19) is connected to the first opening; and the other end of the flue (19) tilts upwards and is connected to an upper space of the baking chamber (11).

4. The pizza oven (100) according to claim 1, wherein the pizza oven (100) further comprises a pellet fuel assembly; the pellet fuel assembly comprises a feeding assembly (31) and an ash box (32); the feeding assembly (31) is arranged above the plug-in slot (12) and is connected to the plug-in slot (12); the ash box (32) is arranged below the plug-in slot (12) and is connected to the plug-in slot (12); and when the pellet hopper (21) is plugged into the plug-in slot (12), the feeding assembly (31) is configured to add pellet fuel into the pellet hopper (21); and the ash box (32) is configured to receive ash obtained after combustion of pellet fuel.

5. The pizza oven (100) according to claim 4, wherein the feeding assembly (31) comprises:
a feeding tube (311), wherein the feeding tube (311) is formed with a feeding channel with openings in two ends; a material inlet (17) is provided in a top wall of the plug-in slot (12); the feeding tube (311) is plugged into the plug-in slot (12) through the material inlet (17) to connect the feeding channel with the plug-in slot (12); and
a cover plate (312), wherein the cover plate (312) is covered at the opening in an upper end of the feeding tube (311) and is hinged to the feeding tube (311); and the cover plate (312) has a state of uncovering the feeding channel and a state of blocking the feeding channel.

6. The pizza oven (100) according to claim 4, wherein a material outlet (18) is provided in a bottom wall of the plug-in slot (12) to connect the plug-in slot (12) to a chamber of the ash box (32);
the pellet hopper (21) comprises a hopper body (211) and a carrier plate (212); the carrier plate (212) is obliquely arranged in a compartment of the hopper body (211) and divides the compartment of the hopper body (211) into a first compartment (213) at an upper layer and a second compartment (214) at a lower layer; the carrier plate (212) is provided with several ash holes (2121) to connect the first compartment (213) to the second compartment (214); an ash port (2111) is provided in a bottom wall of the hopper body (211); the ash port (2111) is opposite to the material outlet (18); and ash on the carrier plate (212) falls into the second compartment (214) from the first compartment (213) through the ash holes (2121), and then falls into the ash box (32) through the ash port (2111) and the material outlet (18).

7. The pizza oven (100) according to claim 6, wherein air inlet holes (2112) are provided in a back wall of the hopper body (211) to connect the second compartment (214) to an external environment.

8. The pizza oven (100) according to claim 6, wherein a handle (2113) is arranged on a back wall of the hopper body (211), and the handle (2113) is detachably connected to the hopper body (211).

9. The pizza oven (100) according to claim 1, wherein the gas assembly (22) comprises a gas shell (221); a first mounting piece (2211) is arranged on a peripheral side of the gas shell (221); and the first mounting piece (2211) is configured to be fixedly connected to a back plate of the oven body (1).

10. The pizza oven (100) according to claim 1, wherein the electrical assembly (23) comprises an electrical appliance shell (231); a second mounting piece (2311) is arranged on a peripheral side of the electrical appliance shell (231); and the second mounting piece (2311) is configured to be fixedly connected to a back plate of the oven body (1).
